(19) United States
(12) Patent Application Publication
(10) Pub. No.: US 2008/0127096 A1
(43) Pub. Date: May 29, 2008

(54) Program and method for supporting system design

(75) Inventors: Daisaku Takahashi, Kawasaki (JP); Hiroki Nakatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 11/819,300

(22) Filed: Jun. 26, 2007

Related U.S. Application Data
(63) Continuation of application No. PCT/JP04/19607, filed on Dec. 28, 2004.

(51) Int. Cl. G06F 9/44

(52) U.S. Cl. 717/124

(57) ABSTRACT

A program and method for supporting system design which are capable of determining risks that may occur in operating a proposed system. When client requirements regarding a system to be installed are inputted to a requirement acceptance unit, an item extraction unit extracts risk items that may occur, from risk management information on the basis of the client requirements accepted by the requirement acceptance unit. Then the risk list creation unit creates and outputs a risk list including a list of the risk items extracted by the item extraction unit.

This application is a continuing application, filed under 35 U.S.C. §111(a), of International Application PCT/JP2004/019607, filed Dec. 28, 2004.

### BACKGROUND OF THE INVENTION

(1) Field of the Invention

This invention relates to a program and method for supporting the design of a computer system, and more particularly to a program and method for supporting system design according to client's detailed requirements.

(2) Description of the Related Art

In the case where a computer system to be used in a large-scale organization such as a corporation is introduced, it is desirable that the computer system is installed according to user's requirements as inexpensive as possible. Therefore, a system designer needs to design a system that is capable of efficiently realizing functions as many as possible by using few resources (hardware resources and software resources).

Therefore there has been considered a simulator comprising a function of selecting necessary devices for a computer system, a function of creating a network configuration diagram by using the selected devices as components, and a function of evaluating the created network configuration diagram (for example, refer to Japanese Unexamined Patent Publication No. 2003-101537).

In addition, there has been considered a network management system that has a database for storing information on electronic computers and network devices and is designed to create a network specification diagram satisfying user's requirements from the information and check the network specifications to see if they have sufficient physical elements (for example, Japanese Unexamined Patent Publication No. 5-225104).

By the way, in the case where a large-scale computer system is introduced in a corporation or the like, the configuration of the computer system to be introduced should be decided in detail. In many cases, review sessions are held before the system introduction, in order to conduct infrastructure check for introducing the system. The review sessions are considered as activities for minimizing troubles that may occur after the system introduction.

However, employment of redundant system infrastructure and fast backup for enhancing operation reliability needs cost and energy. On the other hand, the investment effect to the system improvement for reliability enhancement cannot be confirmed unless a trouble actually occurs. As a result, risk hedges in operation might be ignored.

In addition, in recent years, a company (system integrator) that plans the configuration of a system and introduces the system and a company that operates and manages the introduced system may be different. For example, a system is installed by a computer hardware maker and the system is operated by a client or a system management company that is an outsourcee.

In this case, the system integrator is not conscious of system operation and gives the first priority to start up the service. Therefore, the operating side (outsourcee) may take over the system management from the system integrator without understanding risks.

In addition, in many cases, a budget for system installation is determined at the time of system design. Therefore, even if the outsourcee proposes redundant system infrastructure and fast backup when taking over system operation and management, the client may not accept the proposals.

### SUMMARY OF THE INVENTION

This invention has been made in view of foregoing and intends to propose a program and method for supporting system design, which enable objectively estimating risks that exist in operating a proposed system.

To solve the above problems, this invention intends to propose a computer-readable recording medium that stores therein a computer program for supporting design of a computer system, the program causing a computer to execute: accepting inputs of client requirements regarding a system to be installed; and extracting risk items that may occur, from risk management information on the basis of the accepted client requirements, the risk management information including a plurality of risk items including at least one of (1) risks that may occur if resources installable in the system are not employed and risk hedges and (2) risks that may occur if processes executable in system operation are not executed and risk hedges. Further, to solve the above problems, the invention intends to propose a computer-based method for supporting design of a computer system, comprising: accepting inputs of client requirements regarding a system to be installed; and extracting risk items that may occur, from risk management information on the basis of the accepted client requirements, the risk management information including a plurality of risk items including at least one of (1) risks that may occur if resources installable in the system are not employed and risk hedges and (2) risks that may occur if processes executable in system operation are not executed and risk hedges.

The above and other objects of this invention will become apparent from the following description when taken in conjunction with the accompanying drawings which illustrate preferred embodiments of the present invention by way of example.

### BRIEF DESCRIPTION OF THE DRAWINGS

FIG. 1 is a view showing an outline of one embodiment.

FIG. 2 is a view showing a flow of system design and installation in one embodiment.

FIG. 3 is a view showing an example hardware configuration of a computer to be used in one embodiment.

FIG. 4 is a block diagram showing a system design support function.

FIG. 5 is a view showing an example data structure of a check sheet table.

FIG. 6 is a view showing an example data structure of graph information.

FIG. 7 is a view showing an example data structure of template information.

FIG. 8 is a view showing an example data structure of proposal check management information.

FIG. 9 is a view showing an example data structure of feedback management information.

FIG. 10 is a flowchart showing a procedure for outputting capabilities and risks based on system design.

FIG. 11 is a view showing an example system proposal screen.

FIG. 12 is a view showing associations among risk items.

FIG. 13 is a flowchart showing a detailed procedure for creating a check item list.

FIG. 14 is a view showing an example check item list.

FIG. 15 is a flowchart showing a procedure for executing scripts.

FIG. 16 is a flowchart showing a procedure for reflecting evaluation results.

FIG. 17 is a view showing a procedure for outputting graphs.

FIG. 18 is a flowchart showing a procedure for drawing a graph based on design.

FIG. 19 is a flowchart showing a procedure for drawing a graph after risk evaluation.

FIG. 20 is a view showing an example of a risk evaluation result output screen.

### DESCRIPTION OF THE PREFERRED EMBODIMENTS

Hereinafter, preferred embodiments of this invention will be described with reference to accompanying drawings.

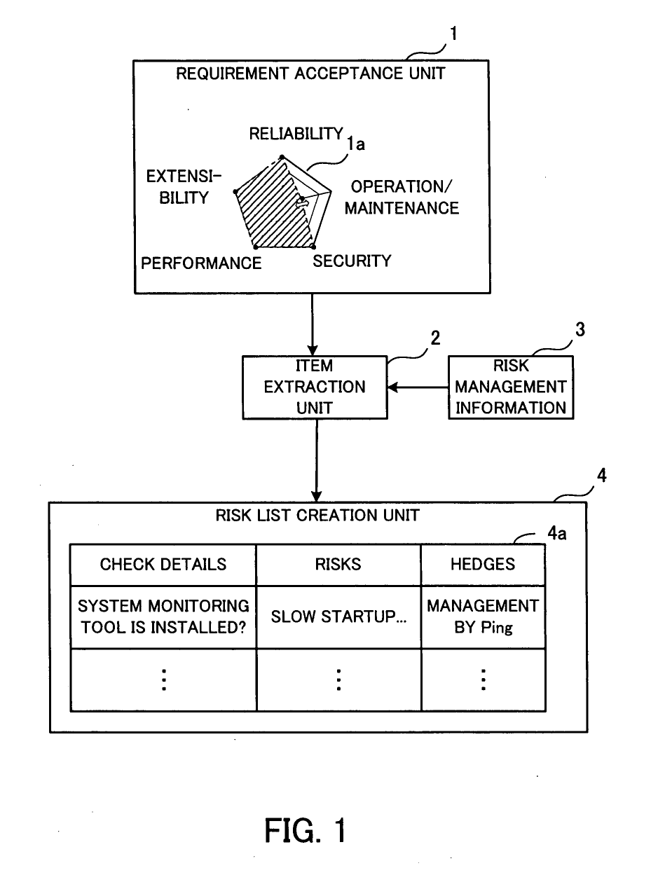

FIG. 1 is a view showing an outline of one embodiment. A requirement acceptance unit 1 accepts inputs of client requirements regarding a system to be installed. For example, the requirement acceptance unit 1 represents the values of characteristics such as reliability, extensibility, performance, security, and operation/maintenance, by the positions of control points on a graph 1a. A user (a client or a service engineer who listened to requirements from the client) inputs the client requirements by changing the positions of the control points on the graph 1a according to specifications desired by the client for the system.

An item extraction unit 2 extracts risk items that may occur, from risk management information 3 on the basis of the client requirements accepted by the requirement acceptance unit 1. In this connection, the risk management information 3 includes a plurality of risk items indicating risks that may occur if resources (including hardware resources and software resources) installable in the system are not employed and risk hedges or indicating risks that may occur if processes (for example, periodical data backup) executable in system operation are not executed and risk hedges.

A risk list creation unit 4 creates and outputs a risk list 4a including a list of the risk items extracted by the item extraction unit 2. The risk list 4a contains risk items each including risk check details (that indicate causes of risks), possible risks, and risk hedges.

When the requirement acceptance unit 1 of a computer realizing such functions accepts inputs of client requirements regarding a system to be installed, the item extraction unit 2 extracts risk items that may occur, from the risk management information 3 on the basis of the client requirements accepted by the requirement acceptance unit 1. Then the risk list creation unit 4 creates and outputs a risk list 4a including a list of the risk items extracted by the item extraction unit 2.

Thereby, such risks can be shown to the client that may occur in operation if certain resources are not employed in the client-desired system or if processes are not executed in operation. As a result, it is easy to incorporate risk hedges that may occur in operation, at the stage of system proposal.

At the time of proposing employment of risk hedges to the client, it is desirable to confirm if the risks are avoided for sure in an actually installed system. In addition, the client incurs costs for implementing the risk hedges. Therefore, after system installation, the system integrator has to give a clear and detailed explanation to the client about that characteristics such as reliability can be improved by employing the risk hedges. Therefore, as this embodiment of this invention, the following describes in detail a computer that is capable of not only outputting risk hedges also objectively outputting the risks and the like that may remain in an installed system, at the stage of system proposal.

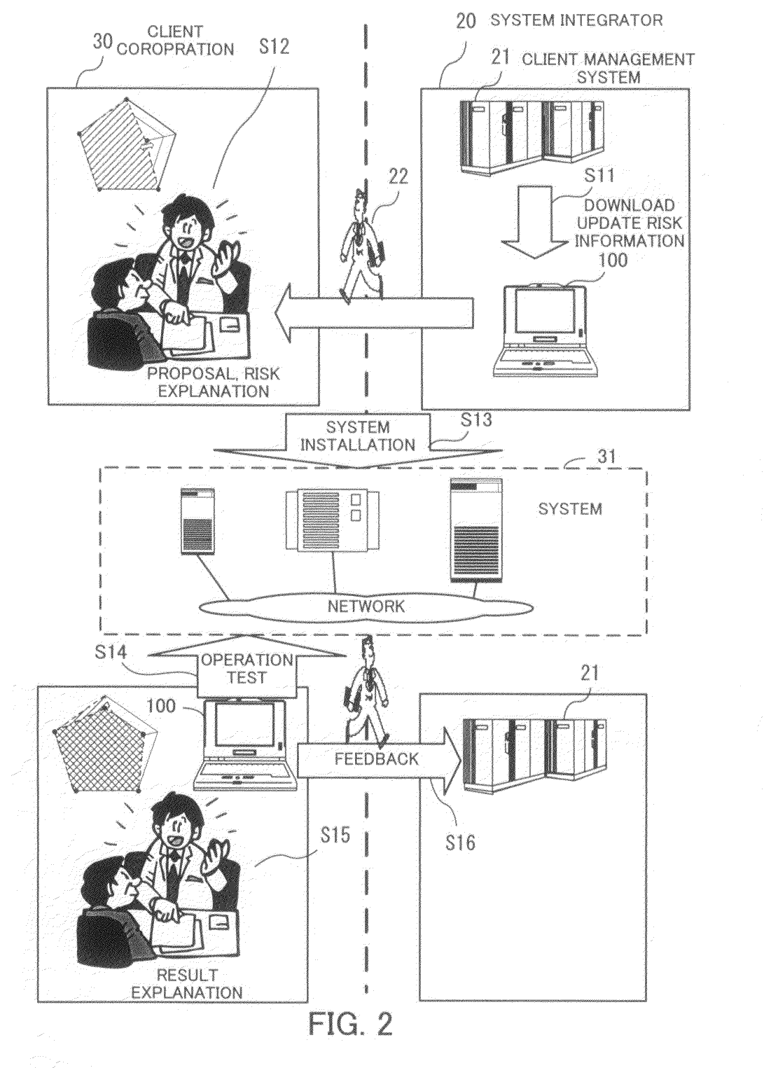

FIG. 2 is a view showing a flow of system design and installation according to this embodiment. A system integrator 20 has a client management system 21. The client management system 21 manages client information and also risk information corresponding to system configuration, which is created based on results of testing previous systems.

A service engineer (SE) 22 of the system integrator 20 downloads update risk information from the client management system 21 to a portable computer 100 such as a notebook personal computer (step S11). Then the SE 22 visits a client corporation 30 with the computer 100 and proposes a system and explains about risks (step S12). At this time, the SE 22 shows, on the computer 100, the client a graph representing the characteristics (functions and risks) of the system proposed based on client requirements. In addition, the SE 22 uses the computer 100 to output a list of risks existing in the proposed system, and explains about the causes of the risks, the possible risks and risk hedges.

If the client accepts introduction of the proposed system, then engineers of the system integrator 20 install the system 31 (step S13). After the system is installed, the SE 22 tests system operation (step S14). The operation test is conducted by connecting the computer 100 to the installed system 31 and running a test program (for example, command scripts) prepared in the computer 100.

Results of the operation test are outputted on the screen of the computer 100. Specifically, the characteristics (functions and risks) of the installed system 31 are outputted in a graph on the screen of the computer 100. The SE 22 shows the outputted graph to the client and gives explanations (step S15). At this time, the SE 22 outputs a list of risks existing in the installed system 31, on the screen of the computer 100, and objectively explains about the risks that exist in future operation of the system 31.

In addition, the SE 22 brings back the computer 100 where the execution results are saved, and uploads the execution results to the client management system 21. Thereby the test results can be fed back to the risk information in the client management system 21 (step S16).

In this way, at the stage of system design, with explanation on the functions of a proposed system and risks in the system by using the computer 100, accidental troubles in system operation can be avoided.

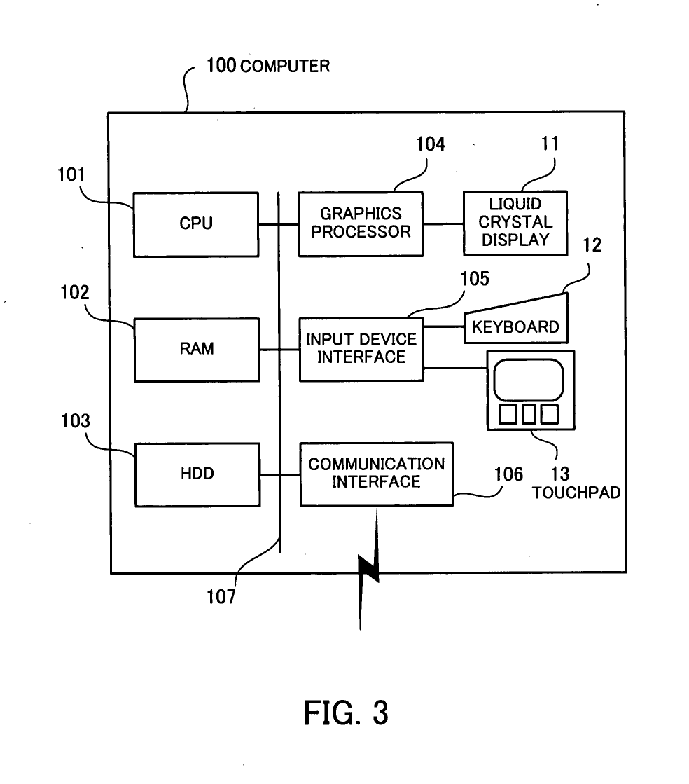

FIG. 3 is a view showing an example hardware configuration of a computer to be used in this embodiment. The computer 100 is entirely controlled by a CPU (Central Processing Unit) 101. Connected to the CPU 101 via a bus 107 are a RAM (Random Access Memory) 102, a Hard Disk Drive (HDD: Hard Disk Drive) 103, a graphics processor 104, an input device interface 105, and a communication interface 106.

The RAM 102 temporarily stores at least part of OS (Operating System) program and application programs to be executed by the CPU 101. In addition, the RAM 102 stores various data required for the CPU's processing. The HDD 103 stores the OS and application programs.

Connected to the graphics processor 104 is a liquid crystal display 11. The graphics processor 104 displays images on the screen of the liquid crystal display 11 under the control of the CPU 101. Connected to the input device interface 105 are a keyboard 12 and a touchpad 13. The input device interface 105 transfers signals from the keyboard 12 and the touchpad 13 to the CPU 101 through the bus 107

The communication interface 106 can be connected to a network. The communication interface 106 performs data communication with other computers via a connected network. For example, in the case where the communication interface 106 is connected to the client management system 21, risk information is transmitted/received. On the other hand, in the case where the communication interface 106 is connected to a system 31 introduced in a client corporation, test commands and responses to the commands are transmitted/received.

With the above hardware configuration, the processing functions of this embodiment can be implemented.

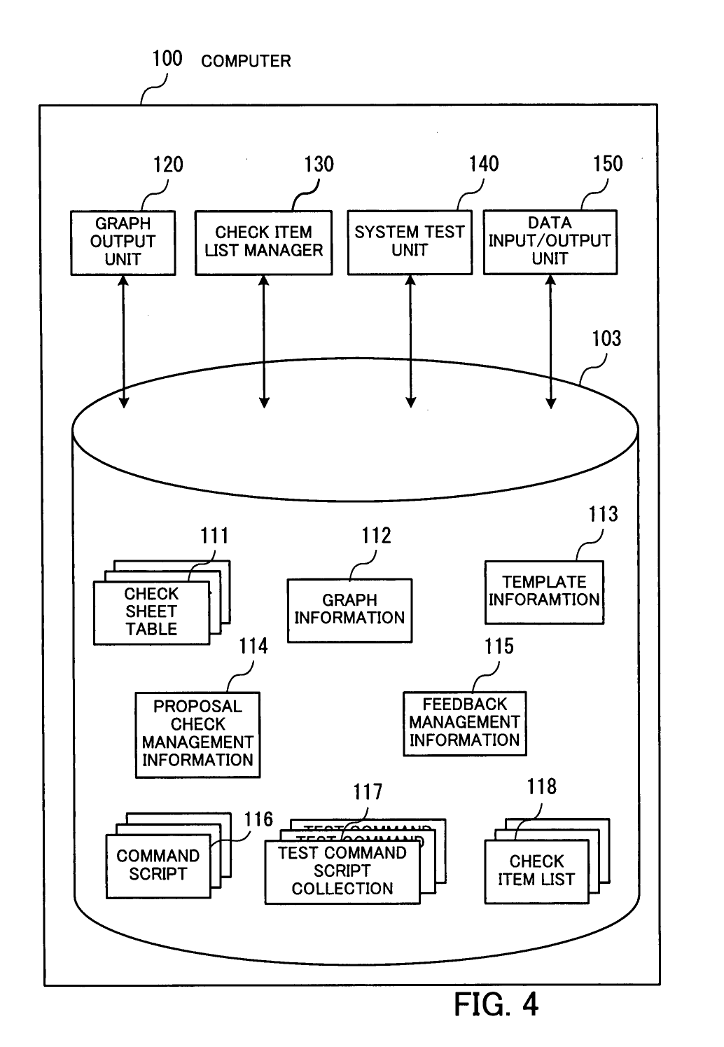

FIG. 4 is a block diagram showing a system design support function. The HDD 103 of the computer 100 stores check sheet tables 111, graph information 112, template information 113, proposal check management information 114, feedback management information 115, command scripts 116, test command script collections 117, and check item lists 118.

A check sheet table 111 is prepared for each of proposal, design, and test. The check sheet table 111 is a data table containing risk items for one of proposal, design, and test. The graph information 112 is a data table containing points of importance (to be used for creating a graph) of each risk item. In this connection, the check sheet tables 111 and the graph information 112 are used for creating the risk management information 3 shown in FIG. 1.

The template information 113 is system configuration information of templates for system design. The template information 113 includes values indicating predicted evaluation values for categories such as reliability and extensibility.

In the proposal check management information 114, a predicted evaluation value at the time of design and an evaluation value resulted from test of an installed system are set for each category. In the feedback management information 115, results of testing the system for proposed risk items are registered. The command script 116 is a program in which the processing contents of test for each test item are described in an arrangement of commands. The test command script collection 117 is a collection of command scripts to be executed for testing an installed system. The check item list 118 is a list of risk items to be tested which are extracted according to the designed system from a check sheet table 111.

To process these data, the computer 100 has a graph output unit 120, a check item list manager 130, a system test unit 140, and a data input/output unit 150.

The graph output unit 120 outputs a graph showing the characteristics of a proposed system or a graph showing the characteristics of an installed system. The check item list manager 130 lists risks existing in a proposed system. The system test unit 140 tests an installed system.

The data input/output unit 150 communicates with the client management system 21 to receive/transmit data. For example, at the time of proposing a system to a client, the data input/output unit 150 obtains update information on the check sheet tables 111, the graph information 112, the template information 113, and the command scripts 116 from the client management system 21 and stores them on the HDD 103. In addition, after the system is tested, the data input/output unit 150 transmits the check item lists 118 created by reflecting the evaluation results, to the client management system 21.

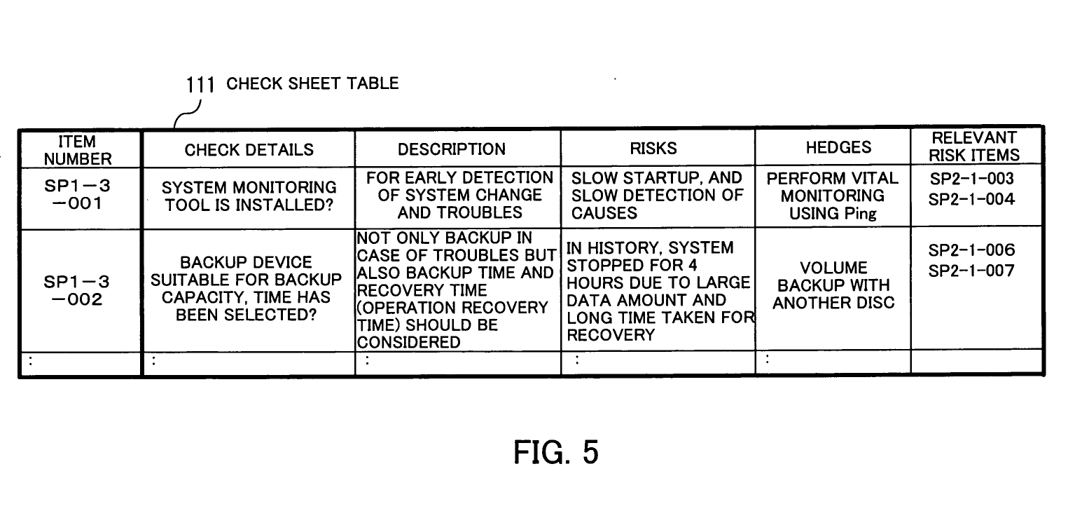

FIG. 5 is a view showing an example data structure of a check sheet table. The check sheet table 111 has columns for item number, check details, description, risks, hedges, and relevant risk items. Information arranged in a row is associated with each other and forms one record.

The item number column has identification numbers (item numbers) of check items. The check detail column is used to set a message indicating functions that cause risks if not employed or indicating the contents of processes that cause risks if not executed. The description column is used to set a message describing in more detail the contents set in the check detail column (for example, a reason why the functions or processes are necessary). The risk column is used to set a message indicating risks that may occur if the functions or processes shown for a corresponding check item are not employed. The hedge column is used to set risk hedges.

The relevant risk item column is used to register the item numbers of relevant risk items of a lower-layer structure. With respect to risk items for proposal, the item numbers of risk items for design/installation are registered in the relevant risk item column. With respect to risk items for design/installation, risk items for test operation are registered in the relevant risk item column. With respect to risk items for test items, the identifiers (script numbers) of command scripts are registered in the relevant risk item column.

In this connection, the data structure of the check item list 118 is almost the same as that of the check sheet table 111, expect that the check item list 118 has another column for registering evaluation results.

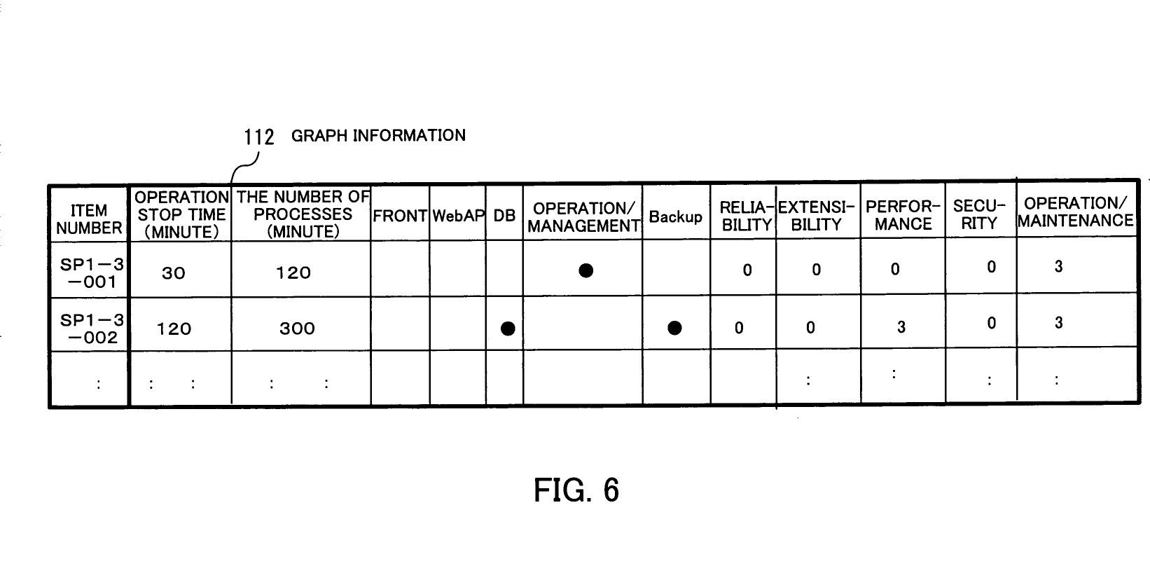

FIG. 6 is a view showing an example data structure of graph information. In the graph information 112, information that is a basis of outputting a graph is set. The graph information 112 has columns for item number, operation stop time, the estimated number of processes, front, Web application (WebAP), database (DB), operation/management, backup (Backup), reliability, extensibility, performance, security and operation/maintenance. Information arranged in a row over the columns is associated with each other and forms one record.

The item number column is used to set the identification numbers (item numbers) of check items. Based on an item number, a check item can be specified from the check sheet table 111. The operation stop time column is used to set, by minute, a stop time of operation during which the functions or processes specified by a corresponding check item are applied to the system. The estimated-number-of-processes column is used to set, by minute, a process time to be taken for engineers to apply the functions or processes specified by a corresponding check item to the system.

The front column is used to set whether or not risk hedges are necessary for a front-end processor (dedicated system for input to/output from a communication circuit). The WebAP column is used to set whether or not risk hedges are necessary for an Web application server. The DB column is used to set whether or not risk hedges are necessary for a database server. The operation/management column is used to set whether or not risk hedges by remote control are necessary for an operation/management server. The Backup column is used to set whether or not risk hedges are necessary for a backup system for a case where a trouble occurs in an operating service. In this figure, functions that require risk hedges are indicated by black dots in the columns.

The reliability column is used to set a point that represents an importance level of reliability. The extensibility column is used to set a point that represents an importance level of extensibility. The performance column is used to set a point that represents an importance level of performance. The security column is used to set a point that represents an importance level of security. The operation/maintenance column is used to set a point that represents an importance level of operation, such as simplicity of maintenance.

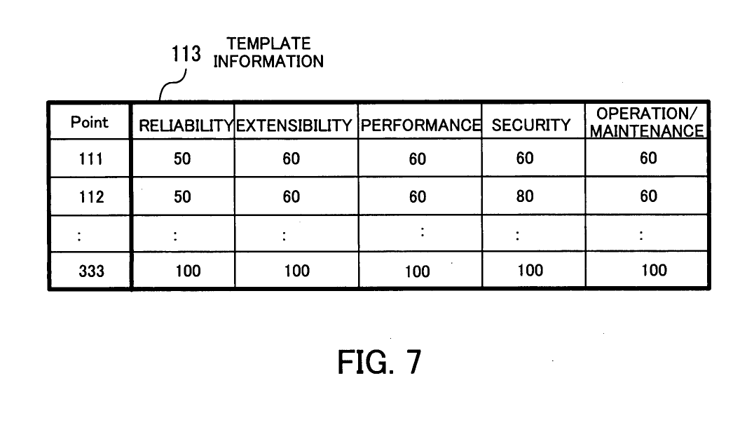

FIG. 7 is a view showing an example data structure of template information. As the template information 113, information to be used as a graph template is set. The template information 113 has columns for point (Point), reliability, extensibility, performance, security, and operation/maintenance. Information arranged in a row over the columns is associated with each other and forms one record.

The point column is used to set the identification information of a check box for selecting client-desired rough specifications. The reliability column is used to set, by percentage, a correction value for a determined reliability value which is used when a corresponding check box is selected. That is, if a check box with reliability of 50 is selected, the determined reliability value is changed to 50% of an original value. The extensibility column is used to set, by percentage, a correction value for a determined extensibility value which is used when a corresponding check box is selected. The performance column is used to set, by percentage, a correction value for a determined performance value which is used when a corresponding check box is selected. The security column is used to set, by percentage, a correction value for a determined security value which is used when a corresponding check box is selected. The operation/maintenance column is used to set, by percentage, a correction value for a determined operation/maintenance value which is used when corresponding check box is selected.

It should be noted that each record is associated with detailed system configuration information that is a system template, which is not illustrated in FIG. 7. Further, the system configuration information, which is a template, shows detailed risks that may occur with the configuration and has a list of risk items for checking the risks.

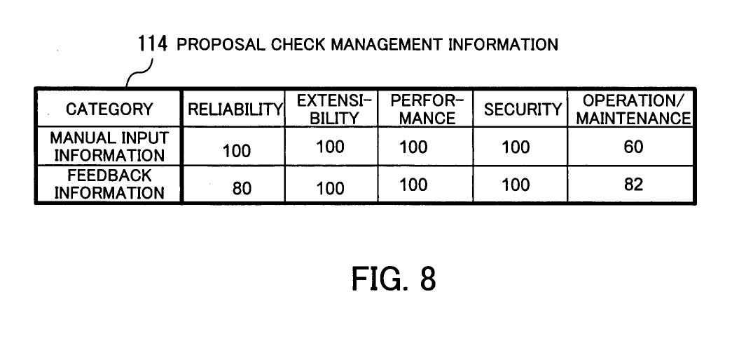

FIG. 8 is a view showing an example data structure of proposal check management information. In the proposal check management information 114, with respect to manual input information and feedback information, a numerical value that is a judgment index regarding functions and risks is set for each category. Referring to the example of FIG. 8, there are categories: reliability, extensibility, performance, security, and operation/maintenance, and there are provided columns each for setting a value for each category.

The manual input information is values entered by numerically expressing required capabilities and acceptable risks for the system to be introduced by the client, as the judgment indexes. In this connection, a value to be set is a value that relatively expresses a level of technique that needs to be employed in the system to be introduced, by taking the existing highest technical level as a numerical value of 100. It should be noted that the numerical value of each category can be changed by moving a control point on a graph being outputted on a screen via a mouse or the like.

The feedback information is numerical values representing results of verifying capabilities and risks with test tools after the system installation. Specifically, evaluation values (OK or NG) obtained by executing test scripts are reflected on the feedback information. In this connection, a value to be set is a value that relatively expresses an evaluation result of the installed system, by taking the existing highest technical level as a numerical value of 100.

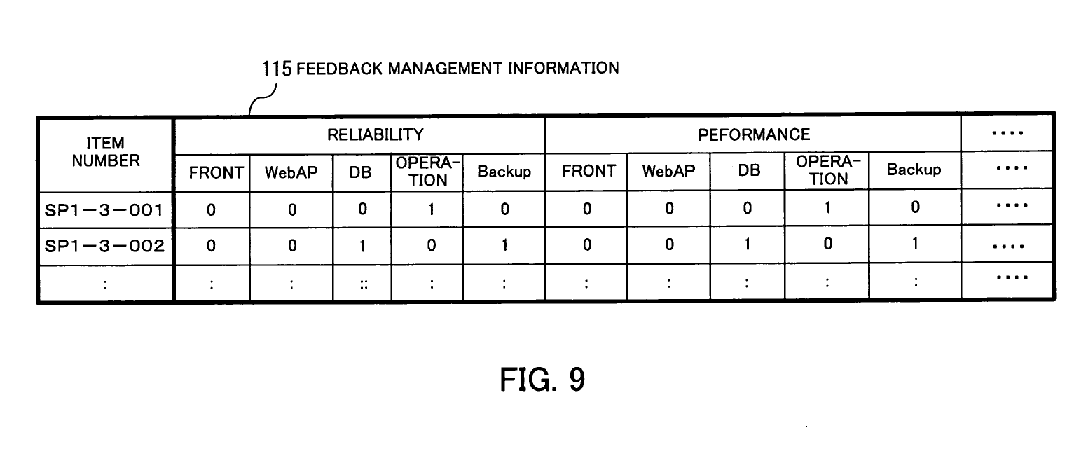

FIG. 9 is a view showing an example data structure of feedback management information. The feedback management information 115 has columns for reliability and performance in association with each item number of an item number column. The reliability and performance column are each divided to sub-columns for front, WebAP, DB, operation, and backup.

An item number is the identification number of a check item indicating whether or not functions or maintenance processes are employed. In the front, WebAP, DB, operation, and backup sub-columns of each of the reliability and performance columns, flag information indicating test evaluation results is set. In the case where a test results in OK, a flag of “1” is set. If a test results in “NG”, a flag of “0” is set.

Processes to be executed on the computer with the above configuration will be now described in detail.

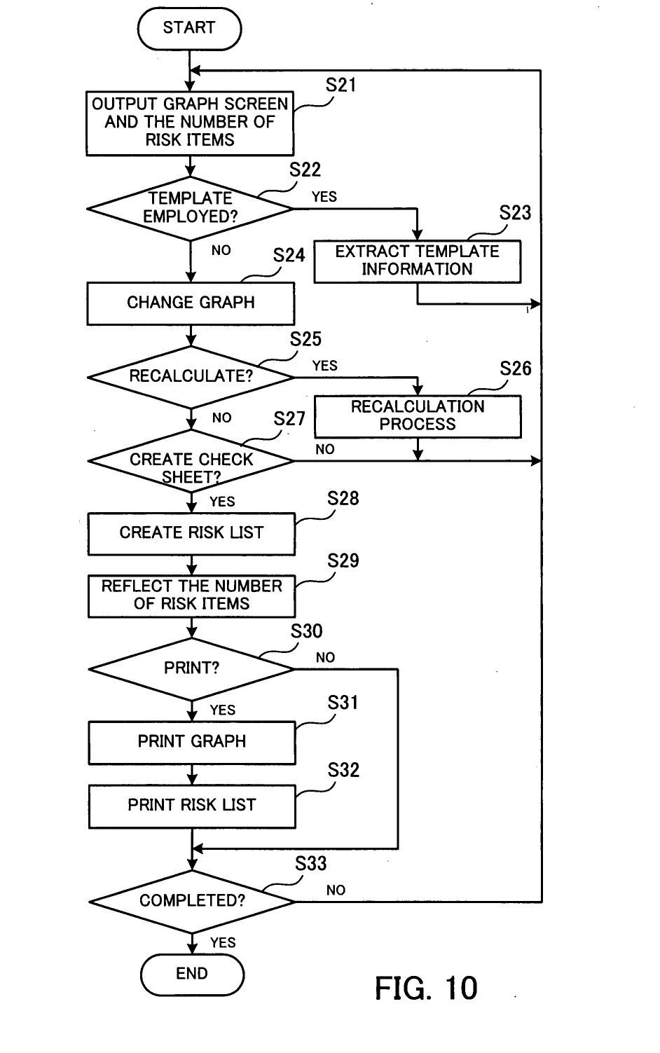

FIG. 10 is a flowchart showing a procedure for outputting capabilities and risks based on system design. The process shown in FIG. 10 will be described in order of step numbers.

[Step S21] The graph output unit 120 outputs a system proposal screen. The system proposal screen includes a graph showing functions and risks and the number of risk items. In this connection, the graph output unit 120 outputs a graph by using default values at an initial state. In this case, the number of risk items appropriate for the outputted graph is set.

On the other hand, in the case where graph data is extracted from the template information 113 at step S23, the graph output unit 120 outputs a graph based on the extracted graph data and outputs the number of risk items that are specified in a template corresponding to the extracted graph data. Further, on the other hand, in the case where control points on the graph are moved by the user at step S24, the graph output unit 120 outputs a graph based on the control points after the movement and also outputs the number of risk items according to the graph.

[Step S22] The graph output unit 120 determines whether to employ the template. Specifically, in the case where check boxes for selecting a template are selected and a template employment button is pressed by the client, the graph output unit 120 recognizes that the template should be employed. In the case where the template is employed, the process goes on to step S23. In the case where a template is not employed, the process goes on to step S24.

[Step S23] The graph output unit 120 determines a template according to the check boxes selected by the client, and obtains the graph data for the template from the template information 113. At this time, the number of risk items preset in the determined template is obtained. Then the process goes to step S21 where the graph and the number of risk items are in turn outputted based on the template.

[Step S24] The graph output unit 120 accepts a graph change operation entered by moving control points on the graph.

[Step S25] The graph output unit 120 determines whether or not recalculation is necessary. Specifically, when the graph is changed before a check sheet creation button is pressed, the graph output unit 120 determines that recalculation is necessary. If recalculation is necessary, the process goes on to step S26. If recalculation is unnecessary, the process goes on to step S27.

[Step S26] The graph output unit 120 recalculates the number of risk items based on the control points on the changed graph. Specifically, the graph output unit 120 obtains a value (of 0 or greater and 1 or smaller) of a control point on each axis of the graph. The value of a control point represents a ratio of check-target risk items to all risk items. Then the graph output unit 120 selects the characteristics (such as reliability and extensibility) set on the axes, one by one.

It is now assumed that reliability is selected. The graph output unit 120 consults the graph information 112 to arrange the check items of the proposal check sheet table 111 in a decreasing order of reliability point. Then, the graph output unit 120 selects risk items as many as the number equivalent to a ratio indicated by the value of the reliability control point on the graph with respect to the total number of proposal risk items, in a decreasing order of reliability point. The selected risk items are taken as check-target risk items.

Similarly, with respect to the other characteristics (extensibility, performance, security, and operation/maintenance), risk items are selected according to the values of control points on the corresponding axes on the graph. Then the total number of selected risk items (a risk item is counted as only one if the risk item is selected for some different characteristics) is calculated as the number of check-target risk items.

After the number of risk items is recalculated in this way, the process goes back to step S21.

[Step S27] The graph output unit 120 determines whether to create a check sheet. Specifically, if a check sheet creation button has been pressed, the graph output unit 120 determines that a check sheet should be created. If the check sheet creation button has not been pressed, on the contrary, the graph output unit 120 determines that the creation of check sheet is unnecessary. In the case where the creation of check sheet is necessary, the process goes on to step S28. In the case where the creation of check sheet is unnecessary, the process goes back to step S21.

[Step S28] The graph output unit 120 creates a risk list. Specifically, the graph output unit 120 extracts information on risk items selected as check targets, from the check sheet table 111 and the graph information 112, to create the list. If no change has been made on the template, a list of risk items set as check targets in the system configuration template is created.

[Step S29] The graph output unit 120 reflects the risk items on the proposal check management information. Specifically, the graph output unit 120 represents, by percentage, a value indicated by the control point set on an axis corresponding to a characteristic on the graph (multiplies a value indicated by the control point by 100), and registers the percentage in association with the manual input information in the proposal check management information 114.

[Step S30] The graph output unit 120 determines whether to execute printing. Specifically, if a print command has been entered, the graph output unit 120 executes printing. In the case of executing printing, the process goes on to step S31. In the case where printing is unnecessary, the process goes on to step S33.

[Step S31] The graph output unit 120 prints the graph.

[Step S32] The graph output unit 120 prints the risk list created at step S28.

[Step S33] The graph output unit 120 determines whether to complete the process. Specifically, the graph output unit 120 determines completion of the process if a command to exit the system proposal screen has been entered. If the command has been entered, the system proposal screen is closed and the risk output process is completed. If the command has not been entered, the process goes back to step S21.

As described above, by setting functions desired by the client for the system to be introduced by using a graph on the system proposal screen, risk items that should be checked for installing the system are selected. Then the number of selected risk items is outputted on the system proposal screen.

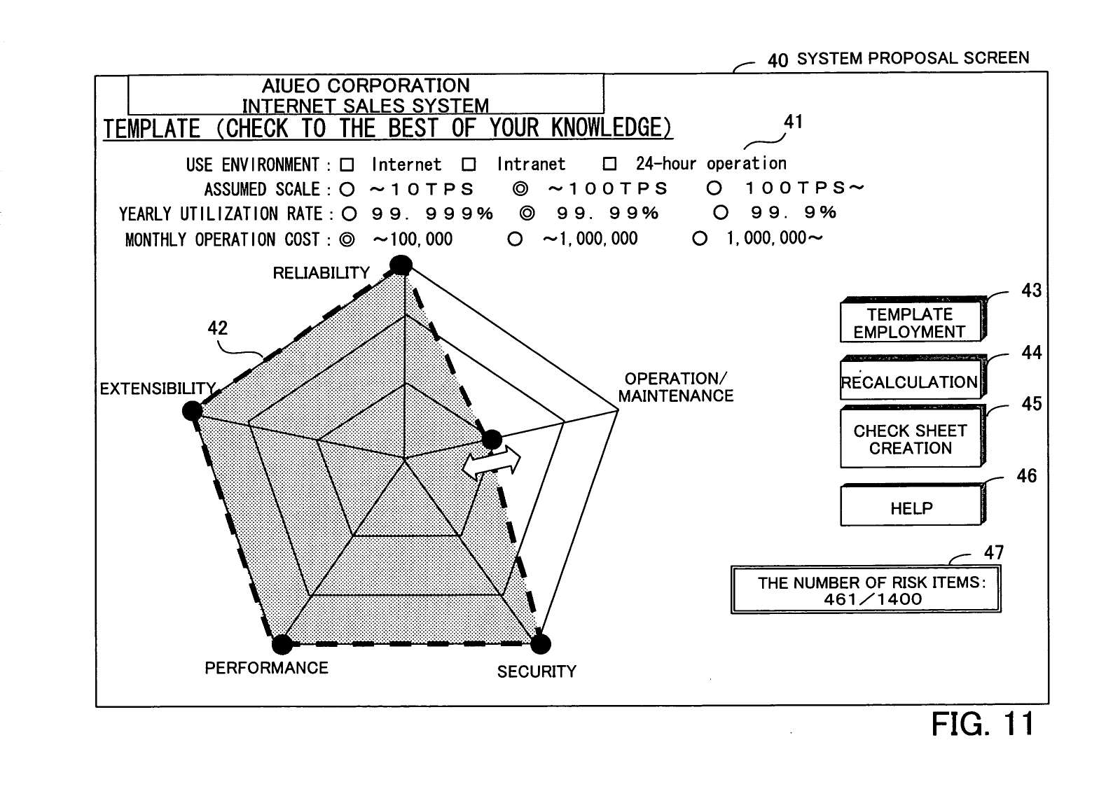

FIG. 11 is a view showing an example system proposal screen. The system proposal screen 40 has a group of template selection check boxes 41, a graph 42, a template employment button 43, a recalculation button 44, a check sheet creation button 45, a help button 46, and a risk item quantity output area 47.

The group of template selection check boxes 41 is a plurality of check boxes for entering criterion for selecting among from a plurality of prepared template data. The group of template selection check boxes 41 includes a plurality of selections for each of use environment, assumed scale, yearly utilization rate, and monthly operation cost. A check box is prepared for each selection. The user selects a desired selection by specifying a corresponding check box with a mouse cursor or the like.

The use environment is an environment which the client assumes to use a system. As selections for the use environment, “the Internet”, “intranet”, and “24-hour operation” are prepared.

The assumed scale is a system scale that the client assumes. As selections for the assumed scale, “- 10 TPS (Transaction Per Second)” (transactions to be processed in a system per a unit time are less than 10 TPS), “- 100 TPS” (transactions to be processed in a system per a unit time are less than 100 TPS), and “100 TPS -” (transactions to be processed in a system per a unit time are 100 TPS or greater) are prepared.

The yearly utilization rate is a one-year utilization rate of the system that the client assumes. As selections for the yearly utilization rate, “99.999%”, “99.99”, and “99.9%” are prepared.

The monthly operation cost is a system operation cost that the client assumes per month. As selections for the monthly operation cost, “- 100,000” (less than 100,000 yen), “- 1,000,000” (less than 1,000,000 yen), “1,000,000 -” (1,000,000 yen or more) are prepared.

The graph 42 shows functions that the client desires for the system. In this graph 42, an axis is prepared for each of characteristics including reliability, extensibility, performance, security, and operation/management. The value of each characteristic is represented by a control point (dot on each axis in this figure). A figure (pentagon) created by connecting the control points on the axes represents total characteristics of the proposed system.

The control points can be desirably moved by the user by dragging them with the mouse cursor. For example, if the client desires operation/maintenance higher than that currently represented on the outputted graph, the user moves the control point on the axis for operation/maintenance along the axis in a direction away from the center of the graph.

The template employment button 43 is a button for setting a graph and the number of risk items based on a template. When the template employment button 43 is pressed, a template according to a combination of check boxes selected from the group of template selection check boxes 41 is determined, and a graph and the number of risk items based on the template are outputted.

The recalculation button 44 is a button for recalculating the number of risk items. The recalculation button 44 can be pressed if the positions of control points on the graph 42 are desirably changed. When the recalculation button 44 is pressed, the risk items taken as check targets are selected based on the positions of the control points on the graph 42 of this time and the number of selected risk items is outputted.

The check sheet creation button 45 is a button for making a command to create a check sheet for risk items. When the check sheet creation button 45 is pressed, a list of risk items selected based on the shape of the graph 42 currently outputted is created.

The help button 46 is a button for outputting description of executable functions on the system proposal screen 40.

The risk item quantity output area 47 shows the number of risk items that should be checked for the system, according to the characteristics outputted by the graph 42. In the example of FIG. 11, a fractional number is outputted in the risk item quantity output area 47, and the denominator thereof indicates the total number of risk items and the element thereof indicates the number of risk items to be checked.

It should be noted that the group of template selection check boxes 41 shown in FIG. 11 is illustrated by way of example. A template can be selected by entering client requirements in more detail. Alternatively, one or more templates for system configuration are outputted as selections, so as to select a template matching the client requirements from the outputted template selections.

By the way, the risk items are classified into proposal, design/installation, and test. In addition, the risk items have a hierarchical structure with proposal as the highest level, design/installation as the middle level, and test as the lowest level. A risk item of a lower level is associated with one risk item of a higher level. And only when a risk item of a higher level is selected as a check target, the associated risk items of a lower level are selected as selections.

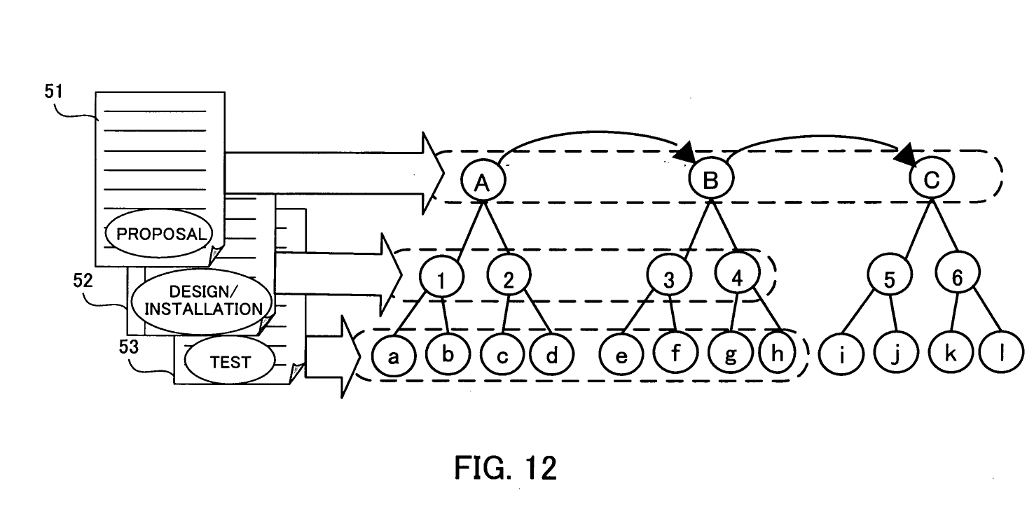

FIG. 12 is a view showing associations among risk items. In this example, to a proposal group 51, risk items “A”, “B”, and “C” belong. To a design/installation group 52, risk items “1”, “2”, “3”, “4”, “5”, and “6” belong. To the test group 53, risk items “a”, “b”, “c”, “d”, “e”, “f”, “g”, “h”, “i”, “j”, “k”, and “l” belong.

Referring to FIG. 12, risk items associated with each other are connected with a line. For example, the risk item “A” is associated with the risk items “1” and “2” of a lower level. The risk item “1” is associated with the risk items “a” and “b” of a lower level. The risk item “2” is associated with the risk items “c” and “d” of a lower level. In this case, if the risk item “A” is not selected as a check target, the risk items “1”, “2”, “a”, “b”, “c”, and “d” are excluded from selections for check targets.

In this way, hierarchical risk items are extracted from each group, and a list of check items is created for each group.

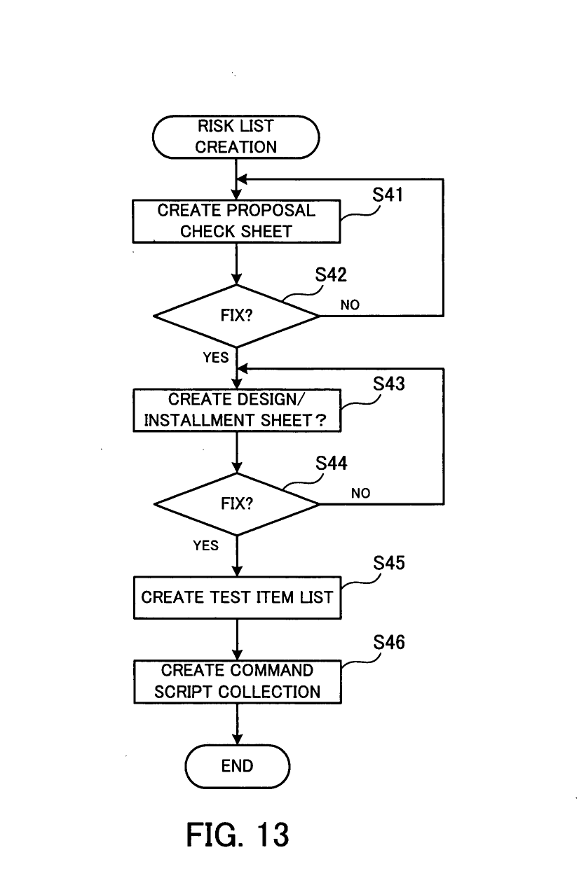

FIG. 13 is a flowchart showing a detailed procedure for creating a check item list. The process of FIG. 13 will be described in order of step numbers.

[Step S41] The check item list manager 130 creates a proposal check sheet. Specifically, the check item list manager 130 extracts risk items belonging to the proposal group, from the risk items selected as check targets. Then the check item list manager 130 obtains information on the extracted risk items from the check sheet table 111 and the graph information 112. Then the check item list manager 130 arranges the obtained information on the risk items to create the check sheet. The created check sheet is outputted on the check item list output screen.

The user fills in prescribed input items (for example, whether to employ hedges against each risk item) on the check sheet. Then after the user completes inputs for all items, the user enters a command to fix the check sheet.

[Step S42] The check item list manager 130 determines whether a command to fix the proposal check sheet has been entered. If the command has been entered, the process goes on to step S43. If the command has not been entered, the process goes back to step S41.

[Step S43] The check item list manager 130 creates a design/installation check sheet. Specifically, the check item list manager 130 extracts risk items belonging to the design/installation group, from the risk items selected as check targets. Then the check item list manager 130 obtains information on the extracted check items from the check sheet table 111 and the graph information 112. The check item list manager 130 arranges the obtained information on the risk items to create the check sheet. The created check sheet is outputted on the check item list output screen.

The user fills in prescribed input items (such as whether to employ hedges against each risk item) on the check sheet. Then after the user completes inputs for all items, the user enters a command to fix the check sheet.

[Step S44] The check item list manager 130 determines whether a command to fix the design/installation check sheet has been entered. If the command has been entered, the process goes on to step S45. If the command has not been entered, the process goes back to step S43.

[Step S45] The check item list manager 130 creates a test item list. Specifically, the check item list manager 130 extracts risk items belonging to the test group from the risk items selected as check targets. Then the check item list manager 130 obtains information on the extracted risk items from the check sheet table 111 and the graph information 112. Then the check item list manager 130 arranges the obtained information on the risk items.

[Step S46] The check item list manager 130 creates a command script collection. Specifically, the check item list manager 130 obtains a command script corresponding to each test item included in the test item list, from the command scripts 116 previously prepared for the test items, takes the obtained command scripts as a test command script collection 117.

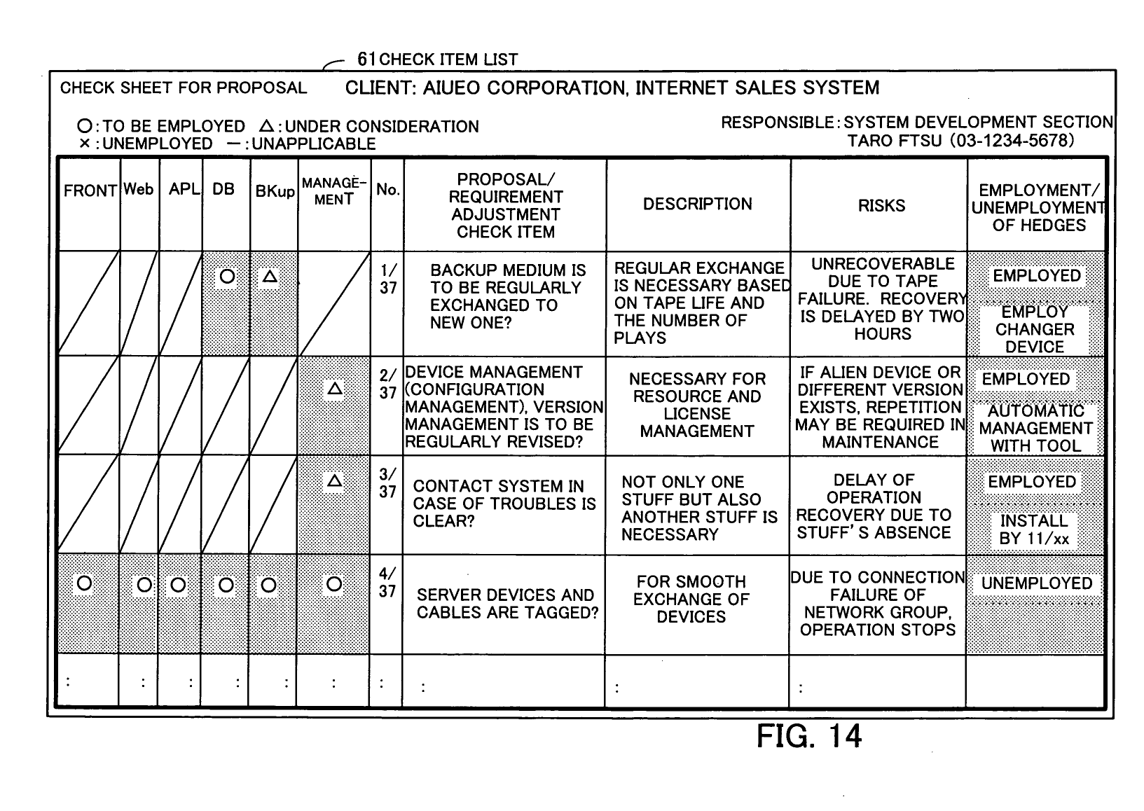

FIG. 14 is a view showing an example of a check item list. FIG. 14 shows a check item list 61 for proposal. The check item list 61 is represented in a form of check sheet for risk items, and it can be entered whether to take risk hedges for each risk item.

The check sheet has columns for functions for which risk hedges are required (“front”, “Web server”, “application server”, “database server”, “backup system”, “management server”), reference number (No.), proposal/requirement adjustment check item, description, risks, and employment or unemployment of hedges.

The column for functions for which risk hedges are required is used to set employment information indicating whether hedges are to be executed for each function. In the example of FIG. 14, a circle mark indicates that hedges are “to be employed”, a triangle mark indicates that it is “under consideration” whether hedges are employed or not, and a cross mark indicates that hedges are “unemployed”. In this connection, a function of a field with a line diagonally drawn means that risk hedges are unnecessary for the function (unapplicable). In addition, fields in which employment information should be set are highlighted by color or the like.

The reference number column is used to set the total number of check-target risk items and an order of a corresponding risk item in the check sheet.

The proposal/requirement adjustment check item column is used to set a message describing events that may be causes of risks. The description column is used to set a message describing the contents of possible risks. The risk column is used to set a message describing problems that may occur if hedges are not employed.

The employment-or-unemployment-of-hedges column is used to set whether or not hedges are employed, and if yes, the hedges are input. Specifically, “employed” is set when hedges are employed, and “unemployed” is set when hedges are not employed. Specific hedges are set in a field.

By outputting risk items to be checked in the check item list 61, omission of risk detection is avoided. Then a check item list is created for each group, and when it is entered in the check item list whether to employ hedges, the system test unit 140 creates a test command script collection for the system.

When the system 31 is installed, the system integrator 20 connects the computer 100 to the system 31. Then the system integrator 20 enters a command to test the system 31, to the computer 100. Then the system test unit 140 executes a test command script collection 117 to thereby test the system 31.

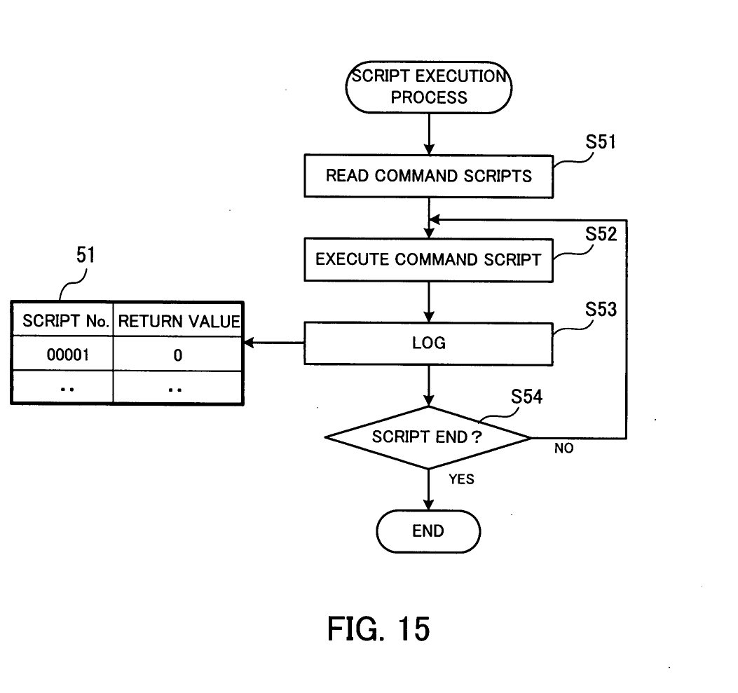

FIG. 15 is a flowchart showing a procedure for executing scripts. The process shown in FIG. 15 will be described in order of step numbers.

[Step S51] The system test unit 140 reads command scripts from a test command script collection 117.

[Step S52] The system test unit 14 selects one unexecuted command script out of the read command scripts, and executes the commands described in the command script.

[Step S53] The system test unit 140 records the result of executing the command script in a log 51. The log 51 is prepared in the RAM 102, and a script number (the identification number of the command script) and a return value are registered in association with each other.

[Step S54] The system test unit 140 determines whether or not execution of all command scripts has been completed. If the execution of all command scripts has been completed, the process is completed. If there is any unexecuted command script, the process goes back to step S52 to execute the unexecuted command script.

In this way, the evaluation results are registered in the log 51. Then the system test unit 140 reflects the evaluation results on the check item list 118.

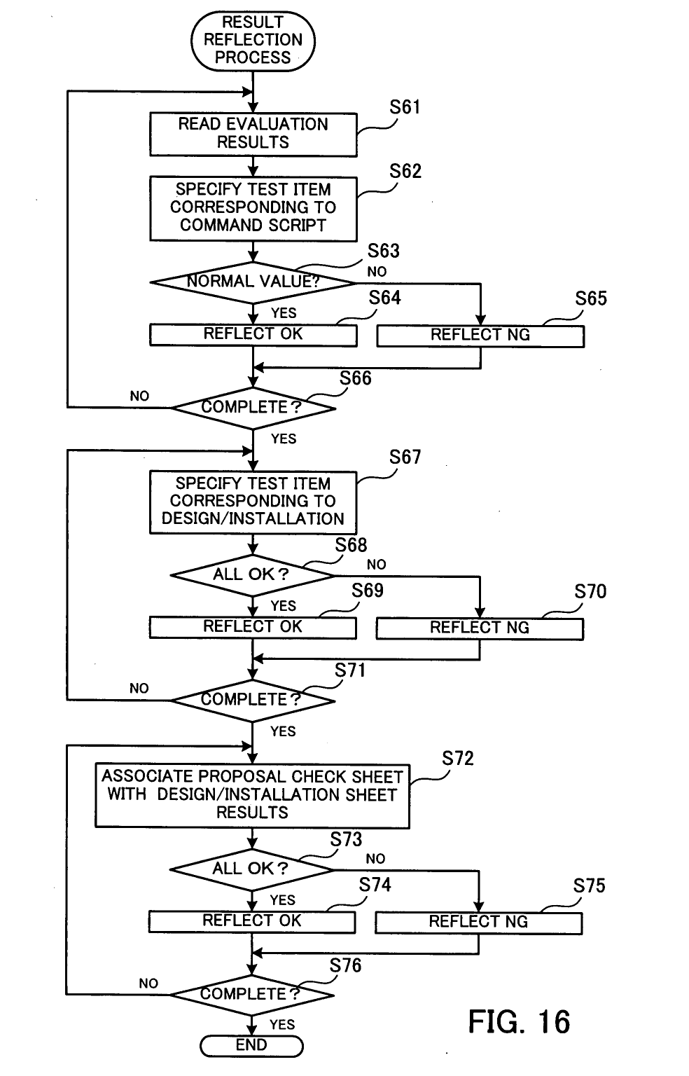

FIG. 16 is a flowchart for reflecting evaluation results. The process of FIG. 16 will be described in order of step numbers.

[Step S61] The system test unit 140 reads one evaluation result that has not been reflected on the test item list, from the evaluation results stored in the log 51.

[Step S62] The system test unit 140 specifies a test item corresponding to the command script by which the evaluation result read at step S61 was obtained, from the test check item list.

[Step S63] The system test unit 140 determines whether the evaluation result is a normal value “1” or an abnormal value “0”. In the case of the normal value, the process goes on to step S64. In the case of the abnormal value, the process goes on to step S65.

[Step S64] The system test unit 140 registers an evaluation result indicating OK (test results in confirming normality) in association with the test item specified at step S62. Then the process goes on to step S66.

[Step S65] The system test unit 140 registers an evaluation result indicating NO (test results in detecting abnormality) in association with the test item specified at step S62.

[Step S66] The system test unit 140 determines whether the process of reflecting the evaluation results on all test items of the test item list is completed. If the evaluation results have been reflected on the all test items, the process goes on to step S67. If there is any test item on which the evaluation results have not been reflected, the process goes back to step S61.

[Step S67] The system test unit 140 selects one risk item from the design/installation check item list, and specifies test items corresponding to the selected risk item, from the test item list.

[Step S68] The system test unit 140 determines whether the evaluation results of the test items corresponding to the selected design/installation risk item are all OK. If the evaluation results are all OK, the process goes on to step S69. If there is at least one evaluation result of NG, the process goes on to step S70.

[Step S69] The system test unit 140 registers an evaluation result indicating OK (test results in confirming normality) in association with the design/installation risk item selected at step S67. The process goes on to step S71.

[Step S70] The system test unit 140 registers an evaluation result indicating NG (test results in detecting abnormality) in association with the design/installation risk item selected at step S67.

[Step S71]. The system test unit 140 determines whether the process of reflecting the evaluation results on all risk items of the design/installation risk item list has been completed. If the evaluation results have been reflected on the all risk items, the process goes on to step S72. If there is any risk item on which the evaluation results have not been reflected, the process goes back to step S67.

[Step S72] The system test unit 140 selects one risk item from the proposal check item list, and specifies design/installation risk items corresponding to the selected risk item from the design/installation risk item list.

[Step S73] The system test unit 140 determines whether the evaluation results of the design/installation risk items corresponding to the selected proposal risk item are all OK. If the evaluation results are all OK, the process goes on to step S74. If there is at least one evaluation result of NG, the process goes on to step S75.

[Step S74] The system test unit 140 registers an evaluation result indicating OK (test results in confirming normality) in association with the proposal risk item selected at step S72. Then the process goes on to step S76.

[Step S75] The system test unit 140 registers an evaluation result indicating NG (test results in detecting abnormality) in association with the proposal risk item selected at step S72.

[Step S76] The system test unit 140 determines whether the process of reflecting the evaluation results on the all risk items of the proposal risk item list has been completed. If the evaluation results have been reflected on the all risk items, the process is completed. If there is any risk item on which the evaluation results have not been reflected, the process goes on to step S72.

Then, after the check results are reflected on the check item list, a graph is outputted on the screen by the graph output unit 120 in response to a command entered by the user.

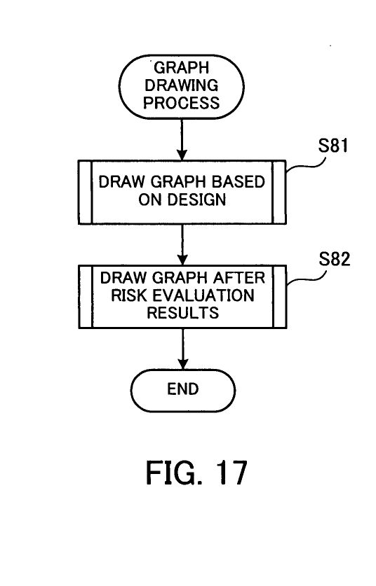

FIG. 17 is a view showing a procedure for outputting a graph. The process shown in FIG. 17 will be described in order of step numbers.

[Step S81] The graph output unit 120 draws a graph based on design.

[Step S82] The graph output unit 120 refers to the check item list 118 on which the test results have been reflected, to draw a graph based on the risk evaluation results, on the graph drawn based on design.

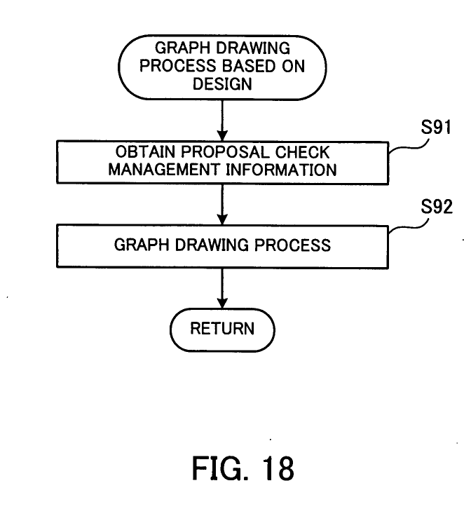

FIG. 18 is a flowchart showing a procedure for drawing a graph based on design. The process of FIG. 18 will be described in order of step numbers.

[Step S91] The graph output unit 120 obtains the proposal check management information 114.

[Step S92] The graph output unit 120 draws a graph based on the manual input information of the obtained proposal check management information 114.

In this way, a graph based on design is drawn.

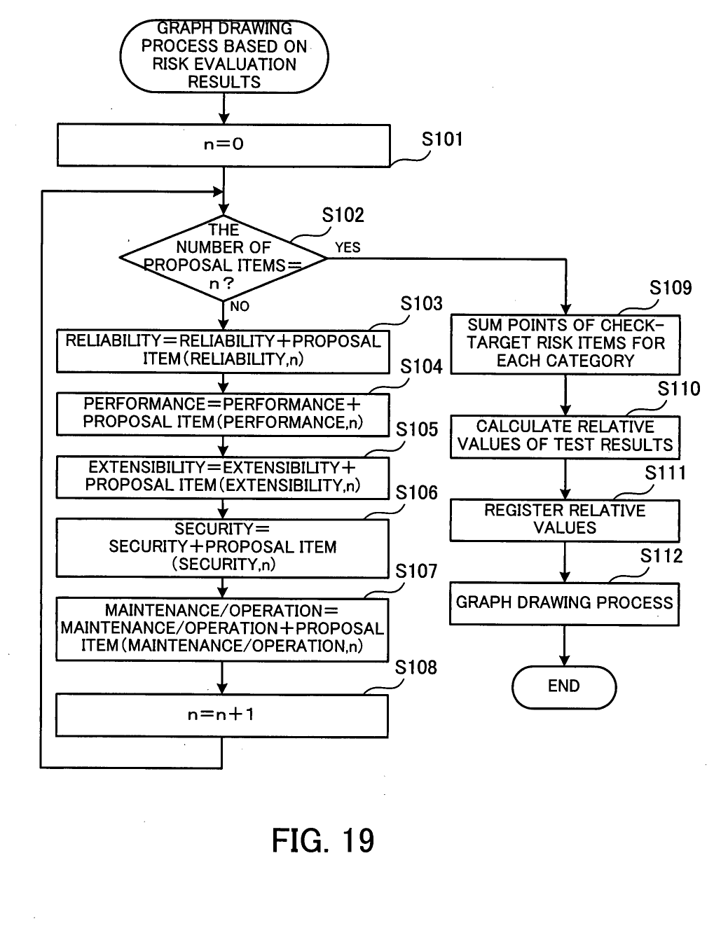

FIG. 19 is a flowchart showing a procedure for drawing a graph after risk evaluation. The process of FIG. 19 will be described in order of step numbers.

[Step S101] The graph output unit 120 sets an initial value of a variable n (n is an integral number of 0 or greater) to 0.

[Step S102] The graph output unit 120 determines whether the number of proposal items is equal to the variable n. If they are equal to each other, the process goes on to step S109. If they are not equal, on the contrary, the process goes on to step S103.

[Step S103] The graph output unit 120 refers to the n-th proposal risk item of the graph information 112, and specifies a test-target function (for example, in the example of FIG. 6, an “operation/management server” is to be tested in the proposal risk item of item number “SP1-3-001”). The graph output unit 120 refers to the n-th proposal risk item of the feedback management information 115, and detects whether the reliability test of the test-target function results in OK of “1” (if there are a plurality of functions to be tested, whether the test results of the all functions are all OK). In the case of all OK, the graph output unit 120 adds a reliability point set for the n-th proposal risk item of the graph information 112 to the current reliability value.

[Step S104] If the performance test result of a test-target function with respect to the n-th proposal risk item is OK, the graph output unit 120 adds the performance point set in the n-th proposal risk item of the graph information 112 to the current performance value.

[Step S105] If the extensibility test result of a test-target function with respect to the n-th proposal risk item is OK, the graph output unit 120 adds the extensibility point set in the n-th proposal risk item of the graph information 112 to the current extensibility value.

[Step S106] If the security test result of a test-target function with respect to the n-th proposal risk item is OK, the graph output unit 120 adds the security point set in the n-th proposal risk item of the graph information 112 to the current security value.

[Step S107] If the operation/maintenance test result of the test-target function with respect to the n-th proposal risk item is OK, the graph output unit 120 adds the operation/maintenance point set in the n-th proposal risk item of the graph information 112 to the current operation/maintenance value.

[Step S108] The graph output unit 120 increments n by one, and the process goes to step S102.

[Step S109] In the case where the value n is equal to the number of proposal risk items, the graph output unit 120 sums the points of each category (reliability, extensibility, performance, security, and operation/maintenance) of the proposal risk items that was selected as check targets at the time of design.

[Step S110] The graph output unit 120 calculates relative values of the test results. Specifically, the graph output unit 120 divides the value of the test results of each category by the total value of the points of the category of the check-target risk items (a ratio of risk items of which the tests resulted in OK to the check-target risk items is calculated). Then the graph output unit 120 multiplies the division result by the value of the category in the manual input information. For example, in the case where the reliability in the manual input information is 100% and the total of points of the test results is 80% with respect to the total of points of the proposal check-target risk items (a division result is 0.8), a relative value of the test results is 80% (100×0.8).

In this connection, the relative value of the test results may be higher than the relative value obtained at the time of design. This is because there are optionally selectable risk items other than the risk items selected as check-target risk items. That is to say, if the test results of desirably selected risk items are OK, the total of points of the risk items of the test results may be higher than the total of points of risk items obtained at the time of design.

[Step S111] The graph output unit 120 registers the relative values of the test results in the columns for the feedback information of the proposal check management information 114.

[Step S112] The graph output unit 120 draws a graph of the test results based on the feedback information of the proposal check management information 114. At this time, the graph output unit 120 draws a transparent graph based on the test results, on the graph drawn based on design.

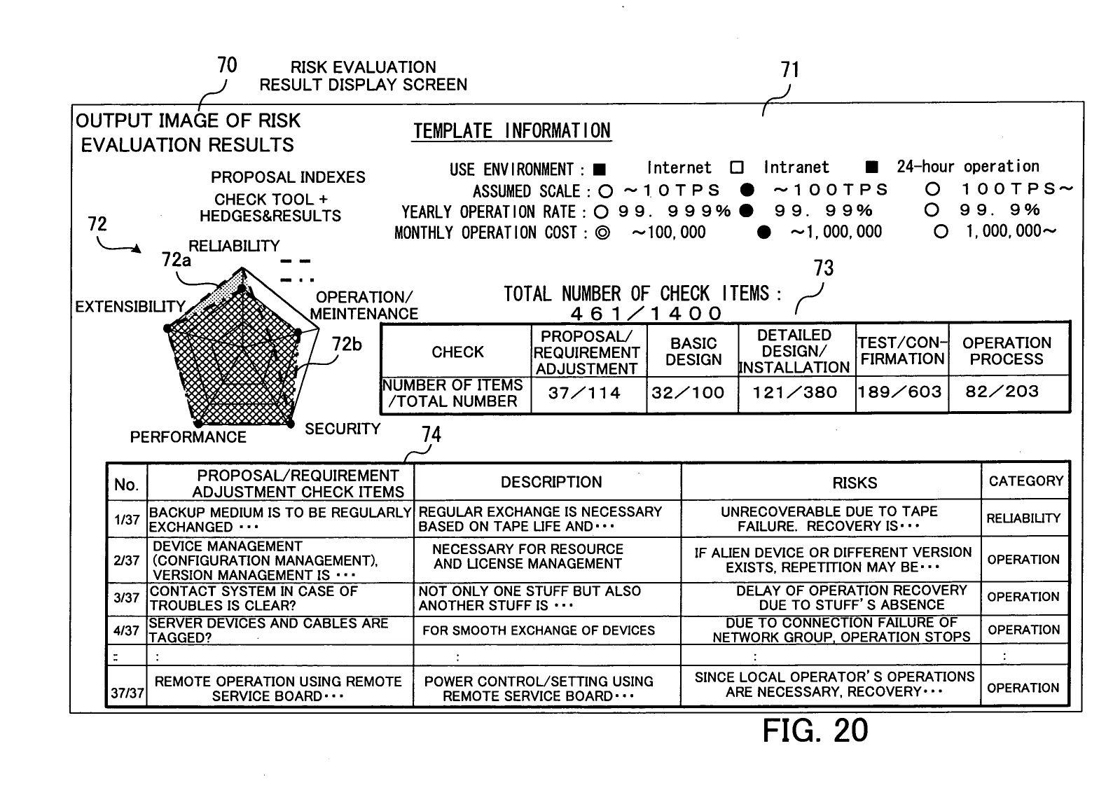

FIG. 20 is a view showing an example risk evaluation result output screen. The risk evaluation result output screen 70 has a template selection result output area 71, a graph 72, a check item quantity output area 73, and a risk output area 74.

The template selection result output area 71 outputs the selections determined in creating a template. In the graph 72, the graph 72a based on design and the graph 72b based on risk evaluation results overlap. As shown in the graph 72a based on design, it can be confirmed that there are potential risks in unsatisfied categories (their values are not the maximum). If the graph 72b based on the risk evaluation results has a higher value for a category, it can be recognized that risks are resolved for the category.

The check item quantity output area 73 outputs the number of tested risk items. The risk output area 74 outputs description on the tested risk items. In this connection, if new risks are discovered from the risk evaluation results, the risk output area 74 outputs information on the risk items as well.

As described above, the proposed system configuration and the actually installed system configuration are visibly outputted in a form of graph, which allows a risk scale to be objectively confirmed. As a result, risks are appropriately confirmed for a manager who is in charge of operation after the system is installed, so that accidental events can be prevented.

In addition, since a check sheet is created by extracting only items relating to the contents of proposal out of design risk items, functions to be employed in the system can be efficiently selected.

Furthermore, the data of risk evaluation results of the system infrastructure is transmitted to the client management system 21 and the data of operation events is accumulated in the client management system 21, so that appropriate risk items can be set based on past operation events.

This invention is designed to extract risk items including risks and risk hedges, on the basis of client requirements and output a list of the risk items. This allows the client to immediately recognize the risks, which may occur in operation if certain resources are not employed in the system to be installed based on the client requirements or if appropriate processes are not executed in operation.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium that stores therein a computer program for supporting design of a computer system, the program causing a computer to execute:
accepting inputs of client requirements regarding a system to be installed; and
extracting risk items that may occur, from risk management information on the basis of the accepted client requirements, the risk management information including a plurality of risk items including at least one of (1) risks that may occur if resources installable in the system are not employed and risk hedges and (2) risks that may occur if processes executable in system operation are not executed and risk hedges.

2. The computer-readable recording medium according to claim 1, wherein the extracting includes extracting the risk items according to a template satisfying the client requirements selected from prepared system configuration templates.

3. The computer-readable recording medium according to claim 1, wherein:
the accepting includes accepting inputs of a numerical value indicating a characteristic desired by a client for the system; and
the extracting includes extracting the risk items as many as a number equivalent to the inputted numerical value, in a decreasing order of importance level.

4. The computer-readable recording medium according to claim 3, further comprising:
accepting inputs to extracted risk items of whether hedges are employed or not; and
selecting test items for the system based on the accepted inputs to the extracted risk.

5. The computer-readable recording medium according to claim 4, further comprising:
executing test programs corresponding to the selected test items; and
determining whether the extracted risk items are hedged in the system based on the test results.

6. The computer-readable recording medium according to claim 5, further comprising outputting a graph representing characteristics of the system based on the test results.

7. A computer-based method for supporting design of a computer system, comprising:
accepting inputs of client requirements regarding a system to be installed; and
extracting risk items that may occur, from risk management information on the basis of the accepted client requirements, the risk management information including a plurality of risk items including at least one of (1) risks that may occur if resources installable in the system are not employed and risk hedges and (2) risks that may occur if processes executable in system operation are not executed and risk hedges.

8. The computer-based method according to claim 7, wherein the extracting includes extracting the risk items according to a template satisfying the client requirements selected from prepared system configuration templates.

9. The computer-based method according to claim 7, wherein:
the accepting includes accepting inputs of a numerical value indicating a characteristic desired by a client for the system; and
the extracting includes extracting the risk items as many as a number equivalent to the inputted numerical value, in a decreasing order of importance level.

10. The computer-based method according to claim 9, further comprising:
accepting inputs to extracted risk items of whether hedges are employed or not; and
selecting test items for the system based no the accepted inputs to the extracted risk.

11. The computer-based method according to claim 10, further comprising:
executing test programs corresponding to the selected test items; and
determining whether the extracted risk items are hedged in the system based on the test results.

12. The computer-based method according to claim 11, further comprising outputting a graph representing characteristics of the system based on the test results.

13. A system design support apparatus for supporting design of a computer system, comprising:
requirement acceptance means for accepting inputs of client requirements regarding a system to be installed;
item extraction means for extracting risk items that may occur, from risk management information on the basis of the client requirements accepted by the requirement acceptance means, the risk management information including a plurality of risk items including at least one of (1) risks that may occur if resources installable in the system are not employed and risk hedges and (2) risks that may occur if processes executable in system operation are not executed and risk hedges.

14. The system design support apparatus according to claim 13, wherein the item extraction means extracts the risk items according to a template satisfying the client requirements selected from prepared system configuration templates.

15. The system design support apparatus according to claim 13, wherein:
the requirement acceptance means accepts inputs of a numerical value indicating a characteristic desired by a client for the system; and
the item extraction means extracts the risk items as many as a number equivalent to the inputted numerical value, in a decreasing order of importance level.

16. The system design support apparatus according to claim 15, further comprising:
hedge input means for accepting inputs to extracted risk items of whether hedges are employed or not; and
test item selection means for selecting test items for the system based on accepted inputs to the extracted risk.

17. The system design support apparatus according to claim 16, further comprising:
test execution means for executing test programs corresponding to the selected test items; and
determination means for determining whether the extracted risk items are hedged in the system based on the test results.

18. The system design support apparatus according to claim 17, further comprising outputting means for outputting a graph representing characteristics of the system based on the test results.
